(19) United States
(12) Patent Application Publication
(10) Pub. No.: US 2026/0353335 A1
(43) Pub. Date: Nov. 5, 2026

(54) METHODS, DEVICES, AND MEDIUM FOR COMMUNICATION

(71) Applicant: NEC CORPORATION, Tokyo (JP)

(72) Inventors: Wei CHEN, Beijing (CN); Ying ZHAO, Beijing (CN); Gang WANG, Beijing (CN)

(73) Assignee: NEC CORPORATION, Tokyo (JP)

(21) Appl. No.: 19/104,878

(22) PCT Filed: Sep. 22, 2022
(86) PCT No.: PCT/CN2022/120678

§ 371 Date: Feb. 19, 2025

(51) Int. Cl. H04W 64/00; G01S 5/02; G01S 5/14

(52) U.S. Cl. CPC H04W 64/00; G01S 5/0244; G01S 5/14

(57) ABSTRACT

Example embodiments of the present disclosure relate to a solution for measurement reporting for phase-based positioning. In this solution, a first communication device determines a phase measurement result on at least one reference signal transmitted from at least one second communication device. The first communication device determines, based on a mapping between at least one phase sub-range and at least one quantization level, a quantization level mapped to a phase sub-range into which the phase measurement result falls. The at least one phase sub-range corresponds to a first positioning accuracy for positioning of the first communication device based on the phase measurement result. The first communication device transmits, to a third communication device, information indicating the mapped quantization level.

### FIELD

Example embodiments of the present disclosure generally relate to the field of communication techniques and in particular, to methods, devices, and medium for measurement reporting for phase-based positioning.

### BACKGROUND

Location of a communication device in a communication network can be enabled according to several positioning methods. As some examples, some positioning methods may be based on Enhanced Cell Identity (E-CID), Downlink Time Difference of Arrival (DL-TDOA), Uplink-TDOA (UL-TDOA), Multi-Round Trip Time (Multi-RTT), Downlink Arrival of Departure (DL-AoD) and Uplink Angle-of-Arrival (UL-AoA). In many positioning procedures, one or more reference signals are sent from other devices (e.g., network devices) to the communication device (e.g., a terminal device). The location of the communication device may be determined based on measurement results related to the reference signals. Current positioning methods may achieve meter level positioning accuracy. Higher positioning accuracy is always desired in some scenarios. It is now under discussion positioning based on a measured received phase of a reference signal, which may then introduce measurement reporting of phase-based positioning.

### SUMMARY

In general, embodiments of the present disclosure provide methods, devices and computer storage medium for measurement reporting for phase-based positioning.

In a first aspect, there is provided a communication method. The method comprises: determining, at a first communication device, a phase measurement result on at least one reference signal transmitted from at least one second communication device; determining, based on a mapping between at least one phase sub-range and at least one quantization level, a quantization level mapped to a phase sub-range into which the phase measurement result falls, the at least one phase sub-range corresponding to a first positioning accuracy for positioning of the first communication device based on the phase measurement result; and transmitting, to a third communication device, information indicating the mapped quantization level.

In a second aspect, there is provided a communication method. The method comprises: receiving, at a third communication device and from a first communication device, information indicating a quantization level for a phase measurement result on at least one reference signal, the at least one reference signal being transmitted from at least one second communication device to the first communication device; determining a phase sub-range mapped to the quantization level based on a mapping between at least one phase sub-range and at least one quantization level, the phase measurement result falling into the determined phase sub-range, and the at least one phase sub-range corresponding to a first positioning accuracy for positioning of the first communication device based on the phase measurement result; and performing a positioning procedure for the first communication device based at least in part on the determined phase sub-range.

In a third aspect, there is provided a first communication device. The first communication device includes a processing unit; and a memory coupled to the processing unit and storing instructions thereon, the instructions, when executed by the processing unit, causing the device to perform the method according to the first aspect.

In a fourth aspect, there is provided a third communication device. The third communication device includes a processing unit; and a memory coupled to the processing unit and storing instructions thereon, the instructions, when executed by the processing unit, causing the device to perform the method according to the second aspect.

In a fifth aspect, there is provided a computer readable medium having instructions stored thereon, the instructions, when executed on at least one processor, causing the at least one processor to carry out the method according to the first aspect.

In a sixth aspect, there is provided a computer readable medium having instructions stored thereon, the instructions, when executed on at least one processor, causing the at least one processor to carry out the method according to the first aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of measurement reporting for phase-based positioning in accordance with some embodiments of the present disclosure;

FIG. 3A illustrates a diagram showing an example of how a distance between a transmitter and a receiver can be expressed as a phase domain representation in accordance with some embodiments of the present disclosure;

FIG. 3B illustrates a diagram showing an example of waves of a reference signal in accordance with embodiments of the present disclosure;

FIG. 4 illustrates a diagram showing an example of a DL-AoD calculated at a communication device in accordance with embodiments of the present disclosure;

FIG. 5 illustrate a flowchart of a communication method implemented at a first communication device in accordance with some embodiments of the present disclosure;

FIG. 6 illustrate a flowchart of a communication method implemented at a third communication device in accordance with some embodiments of the present disclosure; and

FIG. 7 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

Embodiments of the present disclosure provide a solution for measurement reporting for phase-based positioning.

Principles and implementations of the present disclosure will be described in detail below with reference to the figures.

### Example of Communication Environment

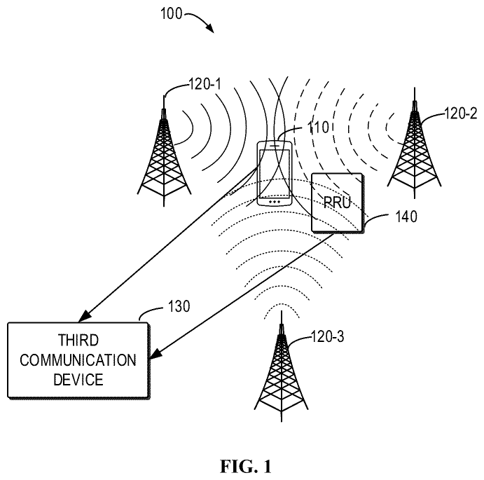

FIG. 1 illustrates a schematic diagram of an example communication environment 100 in which example embodiments of the present disclosure can be implemented. In the communication environment 100, a plurality of communication devices are involved, including a first communication device 110, one or more second communication devices 120-1, 120-2 and 120-3, a third communication device 130, and at least one fourth communication device 140. For the purpose of discussion, the second communication devices 120-1, 120-2, and 120-3 are collectively or individually referred to as second communication devices 120.

It is to be understood that the number of devices and their connections in FIG. 1 are given for the purpose of illustration without suggesting any limitations to the present disclosure. The communication environment 100 may include any suitable number of devices adapted for implementing embodiments of the present disclosure. For example, there may be more first communication devices, and fourth communication devices in the communication environment 100.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, the first communication device 110 may be served by a second communication device 120. In the example of FIG. 1, the first communication device 110 is illustrated as a terminal device while the second communication device 120 is illustrated as a network device, such as a transmission-reception point (TRP). The second communication device 120 which serves the first communication device 110 may be referred to as a serving network device of the first communication device 110. In some example embodiments, if the first communication device 110 is a terminal device and the second communication device 120 is a network device, a link from the second communication device 120 to the first communication device 110 is referred to as a downlink (DL), while a link from the first communication device 110 to the second communication device 120 is referred to as an uplink (UL).

Positioning techniques may be applied to obtain location information of the first communication device 110. In some embodiments, the third communication device 130 may manage device positioning in the communication environment 100. The third communication device 130 may include a location server or controller. In some embodiments, the third communication device 130 may include a network element in a core network (CN) which is configured for location management. In some example embodiments, the third communication device 130 may include a location management function (LMF) although other terminologies may be used.

To determine its location, the first communication device 110 may receive reference signals from other communication devices, such as the second communication devices 120. As used herein, a reference signal refers to a signal sequence which is known by both a transmitter and a receiver. In the context of positioning, the reference signal may include a positioning reference signal (PRS) although other terminologies may be used.

The first communication device 110 may detect certain measurement information about the reference signals. In UE-assisted positioning, the first communication device 110 may transmit the measurement results of the reference signals to the third communication device 130, to determine its location. In UE-based positioning, the first communication device 110 may determine its location locally based on the measurement results and transmit the location to the third communication device 130.

In some embodiments, the fourth communication device 140 in the communication environment 100 may be configured to facilitate the positioning of the first communication device 110. For example, the in-field measurement and classification labelling. The fourth communication device 140 is usually capable of determining its location. In some example embodiments, the fourth communication device 140 may include a positioning reference unit (PRU) although other terminologies may be used.

### Work Principle and Example Process

Some conventional positioning methods are based on time related measurement information or angle related measurement information of a reference signal, such as positioning based on TDOA, RTT, AoD, and AoA. Such positioning methods can achieve meter level positioning accuracy. It is desired to provide more accuracy improvement.

Phase-based positioning is one of promising techniques that provide higher positioning accuracy. The phase-based positioning has been used in the Global Navigation Satellite System (GPS) or Global Navigation Satellite System (GNSS) for centimeter-level positioning accuracy. It is now proposed to introduce phase-based positioning into the communication systems to satisfy the positioning requirement. However, reporting of the phase related measurement information is new to the communication systems. For even phase-based positioning, the accuracy may also depend on the reported measurement information. Without carefully configuring the reporting, the positioning accuracy may be compromised.

Example embodiments of the present disclosure provide a solution for measurement reporting for phase-based positioning. In this solution, a first communication device quantifies a phase measurement result on at least one reference signal transmitted from at least one second communication device based on a mapping between at least one phase sub-range and at least one quantization level. The phase sub-range in the mapping corresponds to a positioning accuracy for positioning of the first communication device based on the phase measurement result. The first communication device then determines a quantization level mapped to a phase sub-range into which the phase measurement result falls, and transmits information indicating the mapped quantization level to a third communication device which needs this information. Upon receipt of the reported information, the third communication device refers to the same mapping, to determine the phase sub-range that is mapped to the received quantization level. Any positioning procedure for the first communication device can be performed based at least in part on the determined phase sub-range.

Through this solution, by quantifying the phase measurement result, the quantization result can be communicated between devices, so as to enable the positioning. In addition, since the quantization is performed by reference to a positioning accuracy for the phase-based positioning, it ensures that the positioning accuracy may be not compromised due to the quantization, and thus positioning services with desired accuracy can be achieved in different applications.

Principles and implementations of the present disclosure will be described in detail below with reference to the figures.

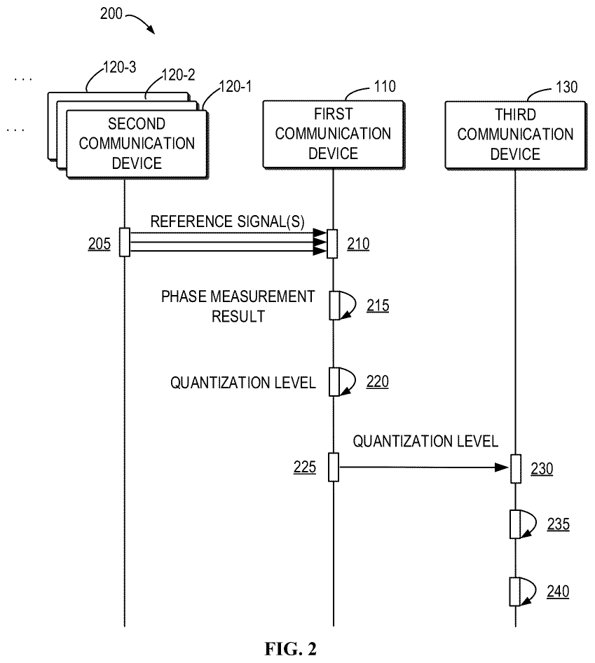

Reference is made to FIG. 2, which illustrates a signaling flow 200 of measurement reporting for phase-based positioning in accordance with some embodiments of the present disclosure. For the purpose of discussion, the flowchart 200 will be described with reference to FIG. 1. The signaling flow 200 involves a first communication device 110, one or more second communication devices (e.g., 120-1, 120-2, and 120-3), and a third communication device 130. It would be appreciated that more or less second communication devices 120 or other communication devices may be involved in the signaling flow 200 in some cases.

In the example embodiments of FIG. 2, at least one second communication device 120 transmits 205 at least one reference signal to the first communication device 110. The first communication device 110 receives 210 the at least one reference signal and determines 215 a phase measurement result on the at least one reference signal. As discussed in the following, the first communication device 110 quantifies the phase measurement result and reports the quantification result to the third communication device 130.

To better understand the embodiments of the present disclosure, it is first described the phase measurement for positioning.

To support phase-based positioning, a phase measurement is performed on a reference signal. The basic principle of phase-based positioning is using carrier phase related measurement to estimate a propagation delay of an arrival path between a transmitter and a receiver. The positioning accuracy relies on at least a carrier frequency of the signal. As an example, it is assumed that a frequency of a signal is 3.5 GHZ, the wavelength is about 0.86 cm. Theoretically, the estimation performance using the carrier phase is better than 10% of the wavelength, and hence a positioning accuracy of less than 0.08 cm can be achieved ideally.

As compared with the conventional timing-based positioning and angel-based positioning, of which the accuracy is highly dependent on the signal bandwidth for the timing-based positioning and the accuracy is limited by the resolution of angles and beams for the angle-based positioning, the phased-based positioning may be more tolerant to narrow bandwidth and lower resolution of angles. Further, higher precision positioning can be achieved by a higher signal frequency (or a shorter wavelength) if the integer ambiguity can be identified since the positioning error is limited by a total wavelength (measured by the received phase q).

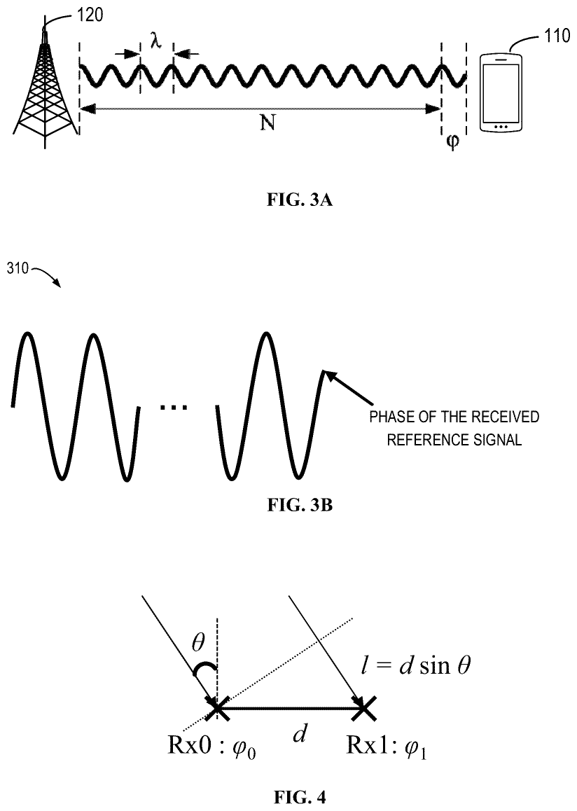

FIG. 3A illustrates a diagram showing an example of how a distance between a transmitter and a receiver can be expressed as a phase domain representation in accordance with some embodiments of the present disclosure. In this example, the transmitter is a second communication device 120 which transmits a reference signal, and the receiver is the first communication device 110 which receives the reference signal. The propagation distance between the second communication device 120 and the first communication device 110 can be expressed by a fractional part and integer multiple of the wavelength. The distance d between the second communication device 120 and first communication device 110 can be represented as follows:

$$d = N λ + \frac{φ}{2 π} λ + ε \qquad ( 1 )$$

where λ represents the wavelength of the reference signal, N represents an integer ambiguity value of the propagated wavelength, φ represents a received phase of the reference signal at the first communication device 110 (also referred to as a phase of received, PoA), and ε represents measurement/estimation error from phase drift due to the transmitter/receiver clock error. The integer ambiguity value N indicates a number of integer wavelengths of the reference signal propagated from the second communication device 120 to the first communication device 110.

Due to the property of the short wavelength of the frequency, measuring the fractional part of the wavelength would be quite useful for high accuracy. Meanwhile, it is noted that the integer ambiguity value N may not be extracted through phase measurement, and the first communication device 110 can measure a phase range from 0 to 2π within a wave, to detect the received phase φ.

FIG. 3B illustrates a diagram showing an example of waves of a reference signal 310 received at the first communication device 110. In this example, the reference signal is illustrated as a sinusoidal carrier signal although other types of signals are also applicable. Theoretically, the received signal can be represented as follows:

y(t)=s(t−τ₀)exp(−j2πf_{c}(t−τ₀)+jφ₀+ε) (2)

where s(t−τ₀) represents an amplitude of the received reference signal, and (−j2πf_{c}(t−τ₀)+jφ₀+ε) represents the phase of the received reference signal. It can be seen that the received phase may be in a range of [0, 2π) in this example.

In some embodiments, the integer ambiguity value N and the received phase φ may be needed, to determine the distance d. If the distances between the first communication device 110 and a plurality of second communication devices 120 are known, it is possible to determine a location of the first communication device 110.

In some embodiments, the received phase φ may be measured in various ways, for example, through a synchronous clock or a Phase Locking Loop (PLL). In some embodiments, there are also many available techniques to obtain the integer ambiguity value N and further techniques to be developed in the further may also be applied. It is noted that the techniques applied to measure the received phase φ and the integer ambiguity value N are not limited in the scope of the present disclosure.

In some embodiments, the phase measurement result that needs to be reported by the first communication device 110 may comprise the received phase φ obtained by measuring the reference signal. In some embodiments, alternatively, or in addition, if the integer ambiguity value N is estimated at the first communication device 110, the phase measurement result may also comprise the integer ambiguity value N. In some embodiments, alternatively, or in addition, the phase measurement result may comprise further related information determined from the received phase, such as a differential phase(s) and/or double differential phase(s), as will be discussed in the following.

Referring back to FIG. 2, the first communication device 110 performs quantization on the phase measurement result, so as to enable reporting of the phase measurement result to the third communication device 130. Specifically, the first communication device 110 determines 220, based on a mapping between at least one phase sub-range and at least one quantization level, a quantization level mapped to a phase sub-range into which the phase measurement result falls. The first communication device 110 transmits 225, to the third communication device 130, information indicating the mapped quantization level.

The at least one phase sub-range corresponds to a positioning accuracy (sometimes referred to as “first positioning accuracy” herein) for positioning of the first communication device 110 based on the phase measurement result.

Through the quantization, the phase measurement result with a continuous value may be mapped to a quantization level with a discrete value. As a result, the quantization level may be represented with a limited number of bits. Generally, the quantization may cause precision loss. In embodiments of the present disclosure, the at least one phase sub-range in the mapping (also referred to as a “mapping table”) for quantization is determined based on the positioning accuracy. In such a way, the positioning accuracy may not be reduced to an undesired level after the quantization.

In some embodiments, the at least one phase sub-range may be divided from a phase range for the phase measurement result. The phase range is a potential value range into which a type of phase measurement may fall. Depending on the types of phase measurement, different phase range may be determined. The phase range may be divided according to a quantization granularity corresponding to the first positioning accuracy. Depending on the quantization granularity, the phase range may be divided to obtain different numbers of phase sub-ranges. In some cases, the phase range may not be divided and thus the whole phase range is mapped to a quantization level.

In some embodiments, the information indicating the quantization level may be comprised in any suitable signaling transmitted to the third communication device 130. In some embodiments, the signaling may include ProvideLocationInformation which may contain location information of different measurements including multiple-RTT, DL-AOD, or DL-TDOA measurements. As an example, the signaling may be defined as follows:

| | |
|---|---|
| ... | |
| [[ nr-ECID-ProvideLocation Information-r16 | OPTIONAL, |
| NR-ECID-ProvideLocationInformation-r16 | |
| nr-Multi-RTT-ProvideLocationInformation-r16 | OPTIONAL, |
| NR-Multi-RTT-ProvideLocationInformation-r16 | |
| nr-DL-AoD-ProvideLocationInformation-r16 | |
| NR-DL-AoD-ProvideLocationInformation-r16 | OPTIONAL, |
| nr-DL-TDOA-ProvideLocationInformation-r16 | |
| NR-DL-TDOA-ProvideLocationInformation-r16 | OPTIONAL |
| nr-DL-POA-ProvideLocationInformation | |
| NR-DL-POA-ProvideLocation Information | OPTIONAL |
| ]] | |
| ... | |

In the above example signaling, the element “nr-DL-POA-ProvideLocationInformation” is added to contain the information related to the phase measurement result. In some embodiments, although not illustrated, the first communication device 110 may transmit the phase measurement result (specifically, the information indicating the mapped quantization level) to the third communication device 130 if required.

The quantization and the used mapping will be discussed in detail below.

In some embodiments, the phase measurement result may comprise at least one received phase φ of at least one reference signal transmitted from the at least one second communication device 120. The range of a received phase φ may be between zero and 2π, as mentioned above. This phase range may be divided into one or more phase sub-ranges each mapped to a quantization level.

In some embodiments, by defining the mapping for quantization, the first positioning accuracy for positioning of the first communication device 110 based on the phase measurement result may be higher than or equal to a second positioning accuracy for timing measurement-based positioning.

The timing measurement-based positioning may be applied in the communication environment to determine the location of the first communication device based on timing measurement, such as RTT or TDOA. In an example, the maximum positioning accuracy or the minimum granularity for timing measurement-based positioning is about 0.153 m.

As for the phase-based measurement, the minimum positioning accuracy or maximum positioning error for phase-positioning may at least depend on a frequency (or wavelength) of the reference signal. An integer phase of the reference signal depends on its frequency. That is, an integer cycle or phase, e.g., from 0 to 2π, represents a linear propagation distance of e.g., 12 cm for 2.5 GHz, and 1 cm for 30 GHz. The positioning accuracy may be improved if the specific received phase can be identified in a small sub-range of the whole integer phase. In other words, if the phase range is divided with higher granularity (into a higher number of phase sub-ranges), the positioning accuracy may be further improved.

In some embodiments, if the first communication device 110 and the second communication devices and the fourth communication devices 120 operates on a relatively low frequency range, for example, FR1 (e.g., 450 MHz to 6000 MHz), the maximum wavelength of the reference signal may not exceed 0.67 m. In order to quantify the received phase φ with a phase range between zero and 2π and keep the first positioning accuracy not lower than the second positioning accuracy for timing measurement-based positioning, at least five quantization levels are required to characterize this phase range. In some examples, to indicate a quantization level with a number of bits, the total number of quantization levels may be 2ⁿ (with n representing the number of bits). Thus, the number of bits required to indicate at least five quantization levels is a least 3 bits. As such, to achieve a more granular division, the phase range from 0 to 2π may be divided into eight phase sub-ranges (with a quantization granularity of 0.25π) and thus eight quantization levels may be mapped respectively to the eight phase sub-ranges. Then, 3-bit information may be used to indicate the eight quantization levels. In this example, the mapping between those phase sub-ranges and quantization levels is summarized in following Table 1.

TABLE 1
Example mapping for a phase range from 0 to 2π

| Reported | Measured | |
|---|---|---|
| Quantization | Quantity | |
| level, Phase_i | Value, POA | Unit |
| Phase_0 | 0 ≤ Phase < 0.25 | π |
| Phase_1 | 0.25 ≤ Phase < 0.5 | π |
| Phase_2 | 0.5 ≤ Phase < 0.75 | π |
| Phase_3 | 0.75 ≤ Phase < 1 | π |
| Phase_4 | 1 ≤ Phase < 1.25 | π |
| Phase_5 | 1.25 ≤ Phase < 1.5 | π |
| Phase_6 | 1.5 ≤ Phase < 1.75 | π |
| Phase_7 | 1.75 ≤ Phase < 2 | π |

In the example of Table 1, “POA” indicates a received phase of a reference signal at the first communication device. The eight quantization levels may be indicated by at least 3 bits. For example, “Phase_0” may be indicated by a bit sequence of “000”, “Phase_1” may be indicated by a bit sequence of “001,” and so on. In some embodiments, if the first communication device 110 needs to report received phases of more than one reference signal from the second communication devices 120, then each of the received phase may be quantified in a similar way.

In some embodiments, if the first communication device 110 and the second communication devices and the fourth communication devices 120 operates on a relatively high frequency range, for example, FR2 (e.g., 24.25 GHz to 52.6 GHz), the maximum wavelength of the reference signal may not exceed 1.24 cm. Theoretically, if a correct integer ambiguity N is determined, the positioning error caused by any received phase error may not exceed the positioning accuracy for the conventional timing measurement-based positioning. In this case, the first communication device 110 may report any random quantization level to indicate the received phase. For example, the phase range from 0 to 2π may be divided into one or two phase sub-ranges which are mapped to one or two quantization levels, respectively. Any quantization level may be represented with one-bit information to be reported to the third communication device 130. It would be appreciated that in some embodiments, the same mapping as in the embodiments of FR1 (e.g., Table 1) may be applied for quantization of the received phase, considering that any quantized value may ensure the positioning accuracy in the case of FR2.

In some embodiments, if it is expected that the first positioning accuracy for positioning based on the phase measurement result not exceeding the second positioning accuracy for timing measurement-based positioning, the mapping between the phase sub-ranges and quantization levels (e.g., the one in Table 1 for FR1) may be configured for the first communication device 110. For example, this mapping may be preconfigured or pre-specified at the first communication device 110 or may be provided by the third communication device 130 or a serving second communication device 120. The first communication device may directly use this mapping to quantify the received phase φ. With the use of the configured mapping, the positioning accuracy based on the received phase φ may at least not be reduced to be lower than the positioning accuracy (e.g., 0.153 m) for timing measurement-based positioning.

In some embodiments, measurement information related to reporting of the received phase may be defined, e.g., referred to as NR-DL-TDOA-SignalMeasurementInformation. A parameter, e.g., referred to as nr-DL-PRS-Phase-Result, may be introduced in the measurement information, to indicate a received phase of a reference signal. As an example, the definition of the information element in a communication specification may be expressed as follows:

```
-----------------------------------Clause 6.5 in TS 37.355-----------------------------------
  <---------------------------Other parts are omitted--------------------------->
  - NR-DL-POA-SignalMeasurementInformation
  NR-DL-POA-MeasElement ::= SEQUENCE {
  ...
```

| | |
|---|---|
| nr-DL-PRS-Phase-Result | INTEGER (0 .. 7), |
| nr-DL-PRS-Phase-LA | INTEGER (0 .. N), |

```
  ...
  }
```

The descriptions of the fields in the measurement information NR-DL-TDOA-SignalMeasurementInformation may be expressed as follows:

```
  CommonIEsRequestLocationInformation field descriptions
  <---------------------------Other parts are omitted--------------------------->
  nr-DL-PRS-Phase-Result
  This field specifies the NR DL-PRS reference signal received phase measurement, as
defined in TS 38.215 [36]. The mapping of the measured quantity is defined as in TS
38.133 [46].
  nr-DL-PRS-Phase-LA
  This field specifies the NR DL-PRS reference signal integer ambiguity with received
phase measurement. A specific number represents the number of carrier wavelength from
the Rx to the Tx.
<---------------------------Other parts are omitted--------------------------->
```

The mapping for quantifying the received phase may be specified as follows:

TABLE 10
----------------------------------------Clause 10.1 in TS 38.133----------------------------------------
<---------------------------Other parts are omitted--------------------------->
The reporting range of absolute PRS phase measurement is defined from 0 to 2π with
0.25π resolution.
The mapping of measured quantity is defined in Table 10.1.xxx. The range in the
signalling may be larger than the guaranteed accuracy range.
Table 10.1.xxx: Measurement report
mapping for PRS-POA

| Reported Quantization level, Phase_i | Measured Quantity Value, POA | Unit |
|---|---|---|
| Phase_0 | 0 ≤ Phase < 0.25 | π |
| Phase_1 | 0.25 ≤ Phase < 0.5 | π |
| Phase_2 | 0.5 ≤ Phase < 0.75 | π |
| Phase_3 | 0.75 ≤ Phase < 1 | π |
| Phase_4 | 1 ≤ Phase < 1.25 | π |
| Phase_5 | 1.25 ≤ Phase < 1.5 | π |
| Phase_6 | 1.5 ≤ Phase < 1.75 | π |
| Phase_7 | 1.75 ≤ Phase < 2 | π |

It would be appreciated that some example specifications are provided above, and the detailed description may be varied.

In some embodiments, a plurality of candidate mappings between phase sub-ranges and quantization levels may be specified for the first communication device 110, with the phase sub-ranges in each mapping corresponding to a different positioning accuracy. One of the plurality of candidate mappings may be selected for use in quantization according to a positioning accuracy requirement for the first communication device 110. The positioning accuracy requirement may indicate an expected positioning accuracy. The mapping selected for use may be corresponding to a positioning accuracy higher than or equal to the expected positioning accuracy in the positioning accuracy requirement.

As some examples, for reporting of the received phase, the phase range from 0 to 2π may be divided with different quantization granularities, to obtain phase sub-ranges with different spans. For example, there may be eight candidate mappings with eight different quantization granularities. Considering the bit representation of information, a candidate mapping may include a total number of 2ⁿ of phase sub-ranges or quantization levels, where n may be 1, 2, 3, and until 8. Then, with a first quantization granularity of 1π, a first candidate mapping between 2 phase sub-range (with a quantization granularity of 1π) and 2 quantization levels is obtained; with a second quantization granularity of 0.5π, a first candidate mapping between 4 phase sub-ranges (with a quantization granularity of 0.5π) and 4 quantization levels is obtained, and so on. Some examples of such candidate mappings may be listed in following Tables.

TABLE 2-1
First candidate mapping with 2 quantization levels

| Reported | Measured | |
|---|---|---|
| Quantization | Quantity | |
| level, Phase_i | Value, POA | Unit |
| Phase_0 | 0 ≤ Phase < 1 | π |
| Phase_1 | 1 ≤ Phase < 2 | π |

TABLE 2-2
Second candidate mapping with 4 quantization levels

| Reported | Measured | |
|---|---|---|
| Quantization | Quantity | |
| level, Phase_i | Value, POA | Unit |
| Phase_0 | 0 ≤ Phase < 0.25 | π |
| Phase_1 | 0.25 ≤ Phase < 1 | π |
| Phase_2 | 1.25 ≤ Phase < 1.5 | π |
| Phase_3 | 1.5 ≤ Phase < 2 | π |

TABLE 2-3
Eighth candidate mapping with 256 quantization levels

| Reported | Measured | |
|---|---|---|
| Quantization | Quantity | |
| level, Phase_i | Value, POA | Unit |
| Phase_0 | 0 ≤ Phase < 0.0078125 | π |
| Phase_1 | 0.0078125 ≤ Phase < 0.015625 | π |
| . . . | | |
| Phase_256 | 1.9921875 ≤ Phase < 2 | π |

It would be appreciated that the above candidate mappings are provided for the purpose of illustration only, and there may be more, less, or different candidate mappings by dividing the phase range for the received phase in different ways and/or defining the mapping relationship in different ways.

As an example, the definition of the candidate mappings between phase sub-ranges and quantization levels in a communication specification may be expressed as follows:

TABLE 10
----------------------------------------Clause 10.1 in TS 38.133----------------------------------------
<---------------------------Other parts are omitted--------------------------->
The reporting range of absolute PRS phase measurement is defined from 0 to 2π with
more than one resolutions.
The mapping of measured quantity is defined in Table 10.1.xxx. The range in the
signalling may be larger than the guaranteed accuracy range.
Table 10.1.xxxa: Measurement report
mapping for PRS-POA for 10

| Reported Quantization level, Phase_i | Measured Quantity Value, POA | Unit |
|---|---|---|
| Phase_0 | 0 ≤ Phase < 1 | π |
| Phase_1 | 1 ≤ Phase < 2 | π |

Table 10.1.xxxb: Measurement report
mapping for PRS-POA for 11

| Reported Quantization level, Phase_i | Measured Quantity Value, POA | Unit |
|---|---|---|
| Phase_0 | 0 ≤ Phase < 0.25 | π |
| Phase_1 | 0.25 ≤ Phase < 1 | π |
| Phase_2 | 1.25 ≤ Phase < 1.5 | π |
| Phase_3 | 1.5 ≤ Phase < 2 | π |

Table 10.1.xxxh: Measurement report
mapping for PRS-POA for 17

| Reported Quantization level, Phase_i | Measured Quantity Value, POA | Unit |
|---|---|---|
| Phase_0 | 0 ≤ Phase < 0.0078125 | π |
| Phase_1 | 0.0078125 ≤ Phase < 0.015625 | π |
| . . . | | |
| Phase_256 | 1.9921875 ≤ Phase < 2 | π |

Generally, the higher the number of quantization levels is, the higher the positioning accuracy is achieved by the corresponding candidate mapping. For example, supposing the frequency of the reference signal is 2.5 GHZ, the positioning accuracy for a candidate mapping with four quantization levels is about 3 cm, the positioning accuracy for a candidate mapping with eight quantization levels is about 1.5 cm, and so on.

If a plurality of candidate mappings corresponding to different positioning accuracies are defined, during operation, the first communication device 110 may determine one of the candidate mappings for use based on the positioning accuracy requirement. For example, if the positioning accuracy requirement indicates an expected positioning accuracy of 3 cm, the first communication device 110 may select the candidate mapping with four quantization levels or with more quantization levels for use.

In some embodiments, the positioning accuracy requirement may be exchanged between the first communication device 110 and the network side. In this way, the same mapping may be applied for quantization by both the communication device 110 and the third communication device 130 at the network side.

In some embodiments, the third communication device 130 or the second communication device 120 which serves the first communication device 110 may transmit the positioning accuracy requirement to the first communication device 110. In some examples, the positioning accuracy requirement may be provided from some other entity in the core network, such as a Gateway Mobile Location Center (GMLC) or from a serving LMF. In some examples, the positioning accuracy requirement may be included in certain signaling such as in NR-DL-POA-RequestLocationInformation.

In some embodiments, the first communication device 110 may decide the expected positioning accuracy and provide the corresponding positioning accuracy requirement to the third communication device 130. In some examples, the first communication device 110 may transmit the positioning accuracy requirement in certain signaling such as in NR-DL-TDOA-ProvideCapabilities.

In some embodiments, measurement information related to reporting of the received phase may be defined, e.g., referred to as NR-DL-TDOA-SignalMeasurementInformation. A parameter, e.g., referred to as nr-DL-PRS-Phase-Result, may be introduced in the measurement information, to indicate a received phase of a reference signal.

In some embodiments, in addition to the received phase or as an alternative, if an integer ambiguity value (or integer ambiguity, for short) for a reference signal transmitted from the communication devices 120 is estimated by the first communication device 110, the first communication device 100 may report further information indicating the integer ambiguity value to the third communication device 130. In some examples, an integer ambiguity value may be reported together with the received phase of the same reference signal, to the third communication device 130.

The integer ambiguity value is a discrete integer value, and thus may be represented using a certain number of bits. In some examples, the integer ambiguity value may be from 0 to (distance/λ), where “distance” is the distance from the communication devices 120 (the transmitter) to the first communication device 110 (the receiver), and λ is the carrier wavelength of the reference signal. In some examples, in a rural scenario with second and fourth communication devices (e.g., network devices) deployed with a distance about 1.2 km, the maximum value for integer ambiguity may not exceed 2791 (by considering different frequencies of signals used). In a urban scenario with a denser deployment of network devices, the maximum value for integer ambiguity may be a smaller one. In some embodiments, the number of bits used to indicate the integer ambiguity value may be configured as a fixed value, to cover different scenarios. In some embodiments, the number of bits used to indicate the integer ambiguity value may be configured dynamically according to the scenarios where the first communication device 110 is located, to reduce the reporting signaling overhead.

As mentioned above, in addition to the received phase and/or the integer ambiguity value, or as an alternative, the phase measurement result may include other phase related measurement, such as differential phase and/or double differential phase.

In some embodiments, the phase measurement result may comprise a differential phase through single differential measurement. In some embodiments, the phase measurement result may comprise a differential phase between received phases of a same reference signal at different antenna of the first communication device 110. This type of differential phase may be determined as a phase difference between the received phases.

FIG. 4 illustrates a diagram showing an example of a differential phase calculated at the first communication device 110. As illustrated, “Rx0” and “Rx1” represents two antennas of the first communication device 110, which detect different beams of a same reference signal transmitted from a certain communication device 120, respectively. The signal received at Rx0 is represented as S₀=A₀ exp(φ₀), and the signal received at Rx1 is represented as

$${S}_{1} = {A}_{1} exp {φ}_{1} = {A}_{1} exp ( {φ}_{0} - \frac{2 π}{λ} d sin θ ) ,$$

where φ₀ represents the received phase at Rx0, 41 represents the received phase at Rx1, d represents the distance between the two antennas, and θ represents a direction of travel. The direction of travel θ may be calculated based on a phase difference between the two received phases as follows:

$$θ = arcsin ( \frac{λ ( {φ}_{0} - {φ}_{1} )}{2 π d} ) \qquad ( 3 )$$

The direction of travel θ may be utilized for various purposes. In some examples, the direction of travel θ may be treated as DL-AoD. Conventionally, DL-AoD is estimated based on reference signal received power (RSRP) measurements from different DL beams from a TRP. The DL-AoD calculated based on the received phases at the first communication device 110 may be more accurate than the RSRP based method. DL-AoD may be further used to determine the location of the first communication device 110, to eliminate errors in the positioning of the first communication device 110, and/or for other purposes. Thus, during the phase measurement, the first communication device 110 may measure the received phases of a certain reference signals at different antennas and report the differential phase, for example, φ₀-φ₁, to the third communication device 130, for determining the direction of travel θ. In this case, as the receiver, the first communication device 110 may be configured with the mapping of reference signal resources into its physical antennas.

In some embodiments, since the differential phase between two antennas is identical in the uniform planar array, therefore the first communication device 110 may report the differential phase with its reference signal resource to the third communication device 130. When quantifying the differential phase, in some embodiments, similarly to the embodiments of reporting the received phase, the mapping corresponding to the positioning accuracy higher than or equal to the second positioning accuracy (e.g., 0.153 m) for timing measurement-based positioning may be configured for the first communication device 110 for use.

Different from the measurement of the received phase, the differential phase between two received phases is valued from a range of [−2π, 2π]. Therefore, the quantization granularity is twice of that for the received phase with the same number of quantization levels. For example, to guarantee that the first positioning accuracy for phase-based positioning not lower than the second positioning accuracy for timing measurement-based positioning, for the frequency range of FR1, the phase range of [−2π, 2π] may be divided into at least 16 phase sub-ranges which are mapped to 16 quantization levels. An example of the mapping may be as follows.

TABLE 3
Example mapping for a phase range from −2π to 2π

| Reported | Measured | |
|---|---|---|
| Quantization | Quantity | |
| level, Phase_i | Value, POA | Unit |
| Phase_0 | −2 ≤ Phase < −1.75 | π |
| Phase_1 | −1.75 ≤ Phase < −1.5 | π |
| . . . | . . . | . . . |
| Phase_15 | 1.75 ≤ Phase < 2 | π |

In some embodiments, if the frequency of the reference signal is in the frequency range of FR2, since the maximum wavelength of the reference signal may not exceed 1.24 cm and the minimum positioning accuracy for the differential phase is about 2.48 cm, which is still higher than the second positioning accuracy for timing measurement-based positioning. Therefore, the first communication device 110 may report any random quantization level to indicate the differential phase between the received phases of the same reference signal at its antennas. The mappings for quantization may be defined in any suitable ways.

In some embodiments, similarly to the embodiments of reporting the received phase, a plurality of candidate mappings between phase sub-ranges and quantization levels may be specified for the first communication device 110, with the phase sub-ranges in each mapping corresponding to a different positioning accuracy. It is appreciated that to obtain the same positioning accuracy as for the direct received phase, the number of quantization levels in a candidate mapping for the differential phase may be as twice as that for the received phase. For example, a first candidate mapping for the differential phase may be as follows:

TABLE 4
First candidate mapping with 2 quantization levels

| Reported | Measured | |
|---|---|---|
| Quantization | Quantity | |
| level, Phase_i | Value, POA | Unit |
| Phase_0 | −2 ≤ Phase < 0 | π |
| Phase_1 | 0 ≤ Phase < 2 | π |

Other candidate mappings may be designed in a similar way, depending on the required positioning accuracy.

In some embodiments, the phase measurement result to be reported may alternatively or additionally include other types of differential phase obtained through single differential measurement. In some embodiments, the other types of differential phase may include a differential phase between received phases of different reference signals from different second communication devices 120 and received by the first communication device 110. In some embodiments, the other types of differential phase may include a differential phase between received phases of a same reference signal from a same second communication device 120 and received by the first communication device 110 and another device, e.g., the fourth communication device 140 (which may be a PRU).

For the differential phase between received phases of different reference signals from different communication devices 120, the first communication device 110 may measure a received phase of a reference signal from a second communication device 120, and another received phase of another reference signal from another second communication device 120, and calculate a difference between the two received phase. The differential phase may be useful for various purposes. In some embodiments, one of the second communication devices 120 involving in calculating the differential phase may include the serving second communication device for the first communication device 110, for example, a serving network device for the terminal device (which is an example of the first communication device 110).

Specifically, for the phase-based positioning, there are some imperfect factors, including time synchronization error, random initial phase error, Allocation and Retention Priority (ARP) position error and clock frequency offset. Some of those factors may be eliminated by differential phase related measurement. For example, the reference signal received by the first communication device 110 from the i-th second communication device 120 may represent a channel response between the two devices, which may be expressed as follows:

yᵢ(t)=s(t−τᵢ)exp(−j2πf_{c}(t−τᵢ)+jφᵢ+ε) (4)

where ε represents a random initial phase error of the first communication device 110.

The received phase φᵢ(t) of the reference signal yᵢ(t) at the first communication device 110 may be measured as:

φᵢ(t)=−j2πf_{c}(t−τᵢ)+jφᵢ+ε (5)

Similarly, the received phase φⱼ(t) of the reference signal from the j-th second communication device 120 and received by the first communication device 110 may be measured as:

φⱼ(t)=−j2πf_{c}(t−τⱼ)+jφⱼ+ε (6)

Then, the differential phase φᵢⱼ(t) between the received phases of the two reference signals from two communication devices 120 may be determined as follows:

φᵢⱼ(t)=−j2πf_{c}(t−τᵢⱼ)+jφᵢⱼ (7)

Through the differential calculation, the random initial phase error ¿ can be eliminated. Accordingly, the differential phase φᵢⱼ(t) is useful and can be reported to the third communication device 130 from the first communication device 110.

In some embodiments, for the differential phase between received phases of a same reference signal from a same second communication device 120 and received by different devices (the first communication device 110 and the fourth communication device 140 (which may be a PRU), the first communication device 110 may measure a received phase of a reference signal from a second communication device 120. The first communication device 110 may receive, from the fourth communication device 140, the received phase of the same reference signal which is measured by the fourth communication device 140. The differential phase may then be calculated as a difference between the two received phase. The calculation of the differential phase may be similar to those shown in above Equations (4)-(7) except that in this case, the received phase is measured with respect to the same reference signal at different receiving devices.

Similar to the differential phase between received phases of different reference signals from different second communication devices 120, the differential phase between received phases of a same reference signal received by different devices may also be useful in error elimination.

As a differential phase between the received phases of different reference signals is calculated as a difference between two received phases, it may be valued from a range of [−2π, 2π]. The mapping used for quantization, including the configuration and/or selection of the mapping for use, may be similar to the embodiments as discussed above, which is omitted here for brevity.

In some embodiments, the phase measurement result may alternatively or additionally include a double differential phase obtained through double differential measurement. The double differential phase may be determined based on a difference between two differential phases. One of the two differential phases may include a differential phase between received phases of different reference signals transmitted from different second communication devices 120 and received by the first communication device 110. The other one of the two differential phases may include a differential phase between received phases of different reference signals transmitted from the same second communication devices 120 as the first differential phases and received by the fourth communication device 140. The first communication device 110 may receive, from the fourth communication device 140, the resulting differential phase or the two direct received phases, to calculate the differential phase.

As the double differential phase is calculated as a difference between two differential phases with a range of [−2π, 2π], the double differential phase may be valued from a range of [−4π, 4π]. Therefore, it can be appreciated that the quantization granularity is twice of that for the differential phase with the same number of quantization levels, or four times of that for the received phase. For example, to guarantee that the first positioning accuracy for phase-based positioning not lower than the second positioning accuracy for timing measurement-based positioning, for the frequency range of FR1, the phase range of [−4π, 4π] may be divided into at least 32 phase sub-ranges which are mapped to 32 quantization levels. The configured mapping and/or the candidate mappings for quantization of the double differential phase may be designed in a similar way as discussed below, by considering the required position accuracy and the phase range for the double differential phase.

In some embodiments, the first communication device 110 may determine and report more than one differential phase and/or double differential phase with respect to different reference signals. The reporting of each differential phase and/or double differential phase may be similar as discussed above.

In some embodiments, if the fourth communication device 140 is involved, it may also measure and report phase measurement results on the reference signals to the third communication device 130. The measuring and reporting of the phase measurement results at the fourth communication device 140 may be similar as those at the first communication device 110. That is, the process of measurement reporting as described with reference to the first communication device 110 may be similarly implemented at the fourth communication device 140, e.g., a PRU.

In some embodiments, although not illustrated, the first communication device 110 may transmit the phase measurement result (specifically, the information indicating the mapped quantization level) to the third communication device 130 if required.

Still referring to FIG. 2, at the side of the third communication device 130, it receives 230 the information indicating the quantization level and uses the same mapping as used by the first communication device 110 to determine the phase represented by the quantization level. Specifically, the third communication device 130 determines 235 a phase sub-range mapped to the quantization level based on the mapping. The third communication device 130 can determine that the phase measurement result reported by the first communication device 110 falls into the determined phase sub-range and may be any phase within the determined phase sub-range.

The mapping used to estimate the phase measurement result may be the same as the one used by the first communication device 110 for quantization. The third communication device 130 may also identify whether the phase measurement result is to indicate the received phase, the integer ambiguity value, a type of differential phase, and/or the double differential phase.

The third communication device 130 performs 240 a positioning procedure for the first communication device 110 based at least in part on the determined phase sub-range. The positioning procedure may involve any suitable positioning operations involved in positioning of the first communication device 110. As some examples, the third communication device 130 may determine a location of the first communication device 110 based on the phase measurement result, such as the integer ambiguity values and the received phases of different reference signals included in the reported result. The phase measurement result, e.g., some differential phase and/or the double differential phase, may be used for error eliminating operations for positioning of the first communication device. As another example, the AoD of a reference signal of a reference signal at the location of the first communication device may be determined, for example, through the differential phase between received phases of this reference signal measured by different antennas of the first communication device 110.

In some embodiments, in the UE-based positioning, the first communication device 110 may determine its location based on the phase measurement result, such as the integer ambiguity values and the received phases of different reference signals. In this case, the first communication device 110 may report the determined location to the third communication device 130. In addition, if required, the first communication device 110 may also report the differential phase(s) and/or the double differential phase as the phase measurement result.

### Example Methods

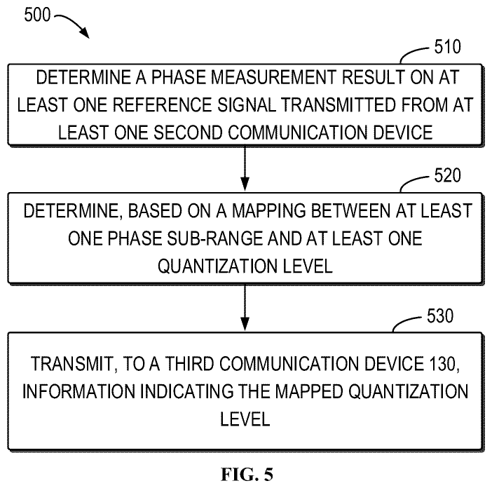

FIG. 5 shows a flowchart of an example communication method 500 implemented at a first communication device in accordance with some example embodiments of the present disclosure. For the purpose of discussion, the method 500 will be described from the perspective of the first communication device 110 in FIG. 1.

At block 510, the first communication device 110 determines a phase measurement result on at least one reference signal transmitted from at least one second communication device.

At block 520, the first communication device 110 determines, based on a mapping between at least one phase sub-range and at least one quantization level. A quantization level mapped to a phase sub-range into which the phase measurement result falls. The at least one phase sub-range corresponds to a first positioning accuracy for positioning of the first communication device based on the phase measurement result.

At block 520, the first communication device 110 transmits, to a third communication device 130, information indicating the mapped quantization level.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing-based positioning.

In some embodiments, the method 500 further comprises: determining a positioning accuracy requirement for the first communication device, the positioning accuracy requirement indicating an expected positioning accuracy; and in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

In some embodiments, the positioning accuracy requirement is received from the third communication device or the at least one second communication device. In some embodiments, the positioning accuracy requirement is provided by the first communication device to the third communication device.

In some embodiments, the phase measurement result comprises a first received phase of a first reference signal transmitted from one of the at least one second communication device. In some embodiments, a phase range for the first received phase is a range between zero and 2π.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication device at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second, or third differential phase is a range between −2π and 2π.

In some embodiments, the phase measurement result comprises: a double differential phase between the second differential phase of the first communication device and a further second differential phase of a further fourth communication device. In some embodiments, a phase range for the double differential phase is a range between −4π and 4π.

In some embodiments, the method 500 further comprises: determining at least one integer ambiguity value for the at least one reference signal, an integer ambiguity value indicating a number of propagated integer wavelengths of a reference signal measured at the first communication device; and transmitting, to the third communication device, further information indicating the at least one integer ambiguity value.

FIG. 6 shows a flowchart of an example communication method 600 implemented at a first communication device in accordance with some example embodiments of the present disclosure. For the purpose of discussion, the method 600 will be described from the perspective of the third communication device 130 in FIG. 1.

At block 610, the third communication device 130 receives, and from a first communication device, information indicating a quantization level for a phase measurement result on at least one reference signal. The at least one reference signal is transmitted from at least one second communication device to the first communication device.

At block 620, the third communication device 130 determines a phase sub-range mapped to the quantization level based on a mapping between at least one phase sub-range and at least one quantization level. The phase measurement result falls into the determined phase sub-range. The at least one phase sub-range corresponds to a first positioning accuracy for positioning of the first communication device based on the phase measurement result.

At block 630, the third communication device 130 performs a positioning procedure for the first communication device based at least in part on the determined phase sub-range.

In some embodiments, performing the positioning procedure comprises at least one of the following: determining a location of the first communication device; performing error eliminating for positioning of the first communication device; or determining an angle of departure (AoD) of a reference signal of the at least one reference signal at the location of the first communication device.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing measurement-based positioning.

In some embodiments, the method 600 further comprises: determining a positioning accuracy requirement for the first communication device, the positioning accuracy requirement indicating an expected positioning accuracy; and in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

In some embodiments, the positioning accuracy requirement is received from the first communication device. In some embodiments, the positioning accuracy requirement is provided by the third communication device or the at least one second communication device to the first communication device.

In some embodiments, the phase measurement result comprises a first received phase of a first reference signal transmitted from one of the at least one second communication device. In some embodiments, a phase range for the first received phase is a range between zero and 2.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second or third differential phase is a range between −2π and 2π.

In some embodiments, the phase measurement result comprises: a double differential phase between the second differential phase of the first communication device and a further second differential phase of a further fourth communication device. In some embodiments, a phase range for the double differential phase is a range between −4π and 4π.

In some embodiments, the method 600 further comprises: receiving, from the first communication device, further information indicating the at least one integer ambiguity value, an integer ambiguity value indicating a number of propagated integer wavelengths of a reference signal measured at the first communication device. In some embodiments, the positioning procedure is performed further based on the at least one integer ambiguity value.

### Example Device

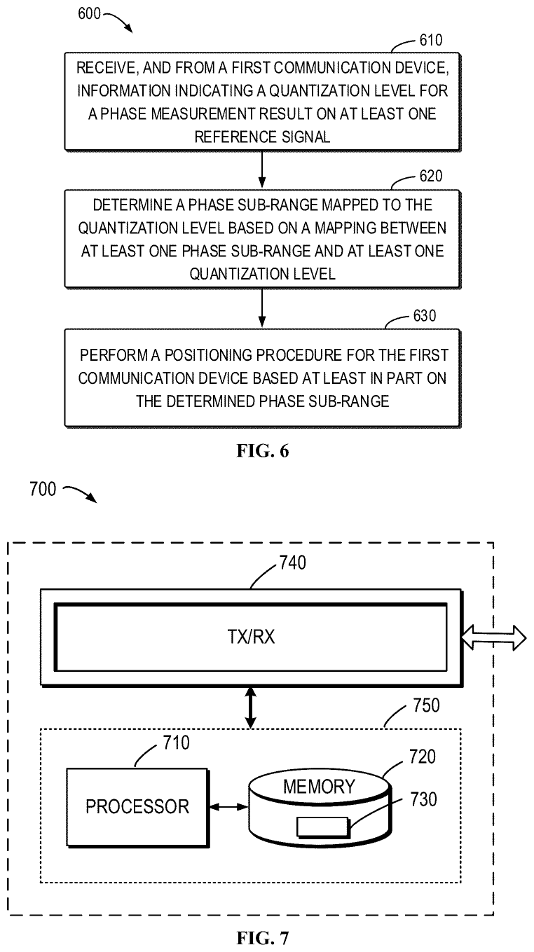

FIG. 7 is a simplified block diagram of a device 700 that is suitable for implementing embodiments of the present disclosure. The device 700 can be considered as a further example implementation of any of the first, second, third, and fourth communication devices as shown in FIG. 1. Accordingly, the device 700 can be implemented at or as at least a part of the first communication device 110 or the third communication device 130.

As shown, the device 700 includes a processor 710, a memory 720 coupled to the processor 710, a suitable transmitter (TX)/receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 730 is assumed to include program instructions that, when executed by the associated processor 710, enable the device 700 to operate in accordance with the embodiments of the present disclosure, as discussed herein with reference to FIGS. 1 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In some embodiments, a communication device (for example, the first communication device or a terminal device) comprises a circuitry configured to: determines, at a first communication device, a phase measurement result on at least one reference signal transmitted from at least one second communication device; determines, based on a mapping between at least one phase sub-range and at least one quantization level, a quantization level mapped to a phase sub-range into which the phase measurement result falls, the at least one phase sub-range corresponding to a first positioning accuracy for positioning of the first communication device based on the phase measurement result; and transmits, to a third communication device, information indicating the mapped quantization level.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing-based positioning.

In some embodiments, the circuitry is further configured to: determine a positioning accuracy requirement for the first communication device, the positioning accuracy requirement indicating an expected positioning accuracy; and in accordance with a determination that the first positioning accuracy is higher than or equal to the target positioning accuracy, select, from a plurality of candidate mappings between phase sub-ranges and quantization levels, the mapping between the at least one phase sub-range and the at least one quantization level.

In some embodiments, the positioning accuracy requirement is received from the third communication device or the at least one second communication device. In some embodiments, the positioning accuracy requirement is provided by the first communication device to the third communication device.

In some embodiments, the phase measurement result comprises a first received phase of a first reference signal transmitted from one of the at least one second communication device. In some embodiments, a phase range for the first received phase is a range between zero and 2π.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication device at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second, or third differential phase is a range between −2π and 2.

In some embodiments, the phase measurement result comprises: a double differential phase between the second differential phase of the first communication device and a further second differential phase of a further fourth communication device. In some embodiments, a phase range for the double differential phase is a range between −4π and 4π.

In some embodiments, the circuitry is further configured to: determine at least one integer ambiguity value for the at least one reference signal, an integer ambiguity value indicating a number of propagated integer wavelengths of a reference signal measured at the first communication device; and transmit, to the third communication device, further information indicating the at least one integer ambiguity value.

In some embodiments, a communication device (for example, the third communication device or a network device) comprises a circuitry configured to: receive, at a third communication device and from a first communication device, information indicating a quantization level for a phase measurement result on at least one reference signal, the at least one reference signal being transmitted from at least one second communication device to the first communication device; determine a phase sub-range mapped to the quantization level based on a mapping between at least one phase sub-range and at least one quantization level, the phase measurement result falling into the determined phase sub-range, and the at least one phase sub-range corresponding to a first positioning accuracy for positioning of the first communication device based on the phase measurement result; and perform a positioning procedure for the first communication device based at least in part on the determined phase sub-range.

In some embodiments, the circuitry is configured to perform the positioning procedure by at least one of the following: determining a location of the first communication device; performing error eliminating for positioning of the first communication device; or determining an angle of departure (AoD) of a reference signal of the at least one reference signal at the location of the first communication device.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing measurement-based positioning.

In some embodiments, the circuitry is further configured to: determine a positioning accuracy requirement for the first communication device, the positioning accuracy requirement indicating an expected positioning accuracy; and in accordance with a determination that the first positioning accuracy is higher than or equal to the target positioning accuracy, select, from a plurality of candidate mappings between phase sub-ranges and quantization levels, the mapping between the at least one phase sub-range and the at least one quantization level.

In some embodiments, the positioning accuracy requirement is received from the first communication device. In some embodiments, the positioning accuracy requirement is provided by the third communication device or the at least one second communication device to the first communication device.

In some embodiments, the phase measurement result comprises a first received phase of a first reference signal transmitted from one of the at least one second communication device. In some embodiments, a phase range for the first received phase is a range between zero and 2π.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second or third differential phase is a range between −2π and 2π.

In some embodiments, the phase measurement result comprises: a double differential phase between the second differential phase of the first communication device and a further second differential phase of a further fourth communication device. In some embodiments, a phase range for the double differential phase is a range between −4π and 4 π.

In some embodiments, the circuitry is further configured to: receive, from the first communication device, further information indicating the at least one integer ambiguity value, an integer ambiguity value indicating a number of propagated integer wavelengths of a reference signal measured at the first communication device. In some embodiments, the positioning procedure is performed further based on the at least one integer ambiguity value.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a communication method comprises: determining, at a first communication device, a phase measurement result on at least one reference signal transmitted from at least one second communication device; determining, based on a mapping between at least one phase sub-range and at least one quantization level, a quantization level mapped to a phase sub-range into which the phase measurement result falls, the at least one phase sub-range corresponding to a first positioning accuracy for positioning of the first communication device based on the phase measurement result; and transmitting, to a third communication device, information indicating the mapped quantization level.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing-based positioning.

In some embodiments, the method further comprises: determining a positioning accuracy requirement for the first communication device, the positioning accuracy requirement indicating an expected positioning accuracy; and in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

In some embodiments, the positioning accuracy requirement is received from the third communication device or the at least one second communication device. In some embodiments, the positioning accuracy requirement is provided by the first communication device to the third communication device.

In some embodiments, the phase measurement result comprises a first received phase of a first reference signal transmitted from one of the at least one second communication device. In some embodiments, a phase range for the first received phase is a range between zero and 2π.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication device at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second, or third differential phase is a range between −2π and 2π.

In some embodiments, the phase measurement result comprises: a double differential phase between the second differential phase of the first communication device and a further second differential phase of a further fourth communication device. In some embodiments, a phase range for the double differential phase is a range between −4π and 4π.

In some embodiments, the method further comprises: determining at least one integer ambiguity value for the at least one reference signal, an integer ambiguity value indicating a number of propagated integer wavelengths of a reference signal measured at the first communication device; and transmitting, to the third communication device, further information indicating the at least one integer ambiguity value.

In another solution, a communication method comprises: receiving, at a third communication device and from a first communication device, information indicating a quantization level for a phase measurement result on at least one reference signal, the at least one reference signal being transmitted from at least one second communication device to the first communication device; determining a phase sub-range mapped to the quantization level based on a mapping between at least one phase sub-range and at least one quantization level, the phase measurement result falling into the determined phase sub-range, and the at least one phase sub-range corresponding to a first positioning accuracy for positioning of the first communication device based on the phase measurement result; and performing a positioning procedure for the first communication device based at least in part on the determined phase sub-range.

In some embodiments, performing the positioning procedure comprises at least one of the following: determining a location of the first communication device; performing error eliminating for positioning of the first communication device; or determining an angle of departure (AoD) of a reference signal of the at least one reference signal at the location of the first communication device.

In some embodiments, the at least one phase sub-range is divided from a phase range for the phase measurement result according to a quantization granularity corresponding to the first positioning accuracy.

In some embodiments, the mapping between the at least one phase sub-range and the at least one quantization level is configured for the first communication device, with the first positioning accuracy being not lower than a second positioning accuracy for timing measurement-based positioning.

In some embodiments, the method further comprises: determining a positioning accuracy requirement for the first communication device, the positioning accuracy requirement indicating an expected positioning accuracy; and in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

In some embodiments, the positioning accuracy requirement is received from the first communication device. In some embodiments, the positioning accuracy requirement is provided by the third communication device or the at least one second communication device to the first communication device.

In some embodiments, the phase measurement result comprises a first received phase of a first reference signal transmitted from one of the at least one second communication device. In some embodiments, a phase range for the first received phase is a range between zero and 2.

In some embodiments, the phase measurement result comprises at least one of the following: a first differential phase between a second received phase of a second reference signal received at a first antenna of the first communication device and a third received phase of the second reference signal received at a second antenna of the first communication device, a second differential phase between a fourth received phase of a third reference signal from a second communication at the first communication device and a fifth received phase of a fourth reference signal from a further second communication device at the first communication device, or a third differential phase between a sixth received phase of a fifth reference signal at the first communication device and a seventh received phase of the fifth reference signal at a fourth communication device. In some embodiments, a phase range for the first, second or third differential phase is a range between −2π and 2π.

In some embodiments, the phase measurement result comprises: a double differential phase between the second differential phase of the first communication device and a further second differential phase of a further fourth communication device. In some embodiments, a phase range for the double differential phase is a range between −4π and 4π.

In some embodiments, the method further comprises: receiving, from the first communication device, further information indicating the at least one integer ambiguity value, an integer ambiguity value indicating a number of propagated integer wavelengths of a reference signal measured at the first communication device. In some embodiments, the positioning procedure is performed further based on the at least one integer ambiguity value.

In further solution, a first communication device comprises: at least one processor; and at least one memory storing instructions that, when executed by the at least one processor, cause the device to perform the method implemented by the first communication device above.

In further solution, a first communication device comprises: at least one processor; and at least one memory storing instructions that, when executed by the at least one processor, cause the device to perform the method implemented by the third communication device above.

In a further solution, a computer readable medium having instructions stored thereon, the instructions, when executed on at least one processor, causing the at least one processor to perform the method implemented by the first communication device above.

In a further solution, a computer readable medium having instructions stored thereon, the instructions, when executed on at least one processor, causing the at least one processor to perform the method implemented by the third communication device above.

In a yet further solution, a computer program comprising instructions, the instructions, when executed on at least one processor, causing the at least one processor to perform the method implemented by the first communication device above.

In a yet further solution, a computer program comprising instructions, the instructions, when executed on at least one processor, causing the at least one processor to perform the method implemented by the third communication device above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A communication method comprising:
determining, at a first communication device, a phase measurement result on at least one reference signal transmitted from at least one second communication device;
determining, based on a mapping between at least one phase sub-range and at least one quantization level, a quantization level mapped to a phase sub-range into which the phase measurement result falls, the at least one phase sub-range corresponding to a first positioning accuracy for positioning of the first communication device based on the phase measurement result; and
transmitting, to a third communication device, information indicating the mapped quantization level.

2. The method of claim 1, wherein the at least one phase sub-range is divided from a phase range for the phase measurement result according to a quantization granularity corresponding to the first positioning accuracy.

3. The method of claim 1, wherein the mapping between the at least one phase sub-range and the at least one quantization level is configured for the first communication device, with the first positioning accuracy being not lower than a second positioning accuracy for timing measurement-based positioning.

4. The method of claim 1, further comprising:
determining a positioning accuracy requirement for the first communication device, the positioning accuracy requirement indicating an expected positioning accuracy; and
in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

5. The method of claim 4, wherein the positioning accuracy requirement is received from the third communication device or the at least one second communication device, or
wherein the positioning accuracy requirement is provided by the first communication device to the third communication device.

6. The method of claim 1, wherein the phase measurement result comprises a first received phase of a first reference signal transmitted from one of the at least one second communication device, and
wherein a phase range for the first received phase is a range between zero and 2×.

7. The method of claim 1, wherein the phase measurement result comprises at least one of the following:
a first differential phase between a second received phase of a second reference signal received at a first antenna of the first communication device and a third received phase of the second reference signal received at a second antenna of the first communication device,
a second differential phase between a fourth received phase of a third reference signal from a second communication device at the first communication device and a fifth received phase of a fourth reference signal from a further second communication device at the first communication device, or
a third differential phase between a sixth received phase of a fifth reference signal at the first communication device and a seventh received phase of the fifth reference signal at a fourth communication device, and
wherein a phase range for the first, second, or third differential phase is a range between −2π and 2π.

8. The method of claim 1 or claim 7, wherein the phase measurement result comprises: a double differential phase between the second differential phase of the first communication device and a further second differential phase of a further fourth communication device, and
wherein a phase range for the double differential phase is a range between −4π and 4π.

9. The method of any of claims 1-8, further comprising:
determining at least one integer ambiguity value for the at least one reference signal, an integer ambiguity value indicating a number of propagated integer wavelengths of a reference signal measured at the first communication device; and
transmitting, to the third communication device, further information indicating the at least one integer ambiguity value.

10. A communication method comprising:
receiving, at a third communication device and from a first communication device, information indicating a quantization level for a phase measurement result on at least one reference signal, the at least one reference signal being transmitted from at least one second communication device to the first communication device;
determining a phase sub-range mapped to the quantization level based on a mapping between at least one phase sub-range and at least one quantization level, the phase measurement result falling into the determined phase sub-range, and the at least one phase sub-range corresponding to a first positioning accuracy for positioning of the first communication device based on the phase measurement result; and
performing a positioning procedure for the first communication device based at least in part on the determined phase sub-range.

11. The method of claim 10, wherein the at least one phase sub-range is divided from a phase range for the phase measurement result according to a quantization granularity corresponding to the first positioning accuracy.

12. The method of claim 10, wherein the mapping between the at least one phase sub-range and the at least one quantization level is configured for the first communication device, with the first positioning accuracy being not lower than a second positioning accuracy for timing measurement-based positioning.

13. The method of claim 10, further comprising:
determining a positioning accuracy requirement for the first communication device, the positioning accuracy requirement indicating an expected positioning accuracy; and
in accordance with a determination that the first positioning accuracy is higher than or equal to the target positioning accuracy, selecting, from a plurality of candidate mappings between phase sub-ranges and quantization levels, the mapping between the at least one phase sub-range and the at least one quantization level.

14. The method of claim 13, wherein the positioning accuracy requirement is received from the first communication device, or
wherein the positioning accuracy requirement is provided by the third communication device or the at least one second communication device to the first communication device.

15. The method of claim 10, wherein the phase measurement result comprises a first received phase of a first reference signal transmitted from one of the at least one second communication device, and
wherein a phase range for the first received phase is a range between zero and 2π.

16. The method of claim 10, wherein the phase measurement result comprises at least one of the following:
a first differential phase between a second received phase of a second reference signal received at a first antenna of the first communication device and a third received phase of the second reference signal received at a second antenna of the first communication device,
a second differential phase between a fourth received phase of a third reference signal from a second communication at the first communication device and a fifth received phase of a fourth reference signal from a further second communication device at the first communication device, or
a third differential phase between a sixth received phase of a fifth reference signal at the first communication device and a seventh received phase of the fifth reference signal at a fourth communication device, and
wherein a phase range for the first, second or third differential phase is a range between −2π and 2π.

17. The method of claim 10 or claim 16, wherein the phase measurement result comprises: a double differential phase between the second differential phase of the first communication device and a further second differential phase of a further fourth communication device, and
wherein a phase range for the double differential phase is a range between −4π and 4π.

18. A first communication device comprising:
at least one processor; and
at least one memory storing instructions that, when executed by the at least one processor, cause the device to perform the method according to any of claims 1-9.

19. A third communication device comprising:
at least one processor; and
at least one memory storing instructions that, when executed by the at least one processor, cause the device to perform the method according to any of claims 10-17.

20. A computer readable medium having instructions stored thereon, the instructions, when executed on at least one processor, causing the at least one processor to perform the method according to any of claims 1-9 or any of claims 10-17.
